(19) United States
(12) Patent Application Publication
(10) Pub. No.: US 2017/0314711 A1
(43) Pub. Date: Nov. 2, 2017

(54) TIGHTENING TOOL FOR TORQUE-LIMITED FITTINGS AND SYSTEMS INCLUDING THE TORQUE-LIMITED FITTINGS

(71) Applicant: Diba Industries, Inc., Danbury, CT (US)

(72) Inventor: Gary C. Helstern, Newtown, CT (US)

(21) Appl. No.: 15/583,299

(22) Filed: May 1, 2017

Related U.S. Application Data
(60) Provisional application No. 62/329,469, filed on Apr. 29, 2016.

(51) Int. Cl. F16L 19/00; B25B 23/142; B25B 23/14

(52) U.S. Cl. CPC F16L 19/00; B25B 23/141; B25B 23/142

(57) ABSTRACT

A tool and methods of use is described. The tool tightens or loosens a fit of torque-limited fittings to respective ports of a fluid-handling device. The tool includes a torque application assembly disposed within a fitting receiving end of a tool body to receive a fitting. The tool body includes a slit between ends to receive a fitting tube. The torque application assembly includes an internal feature and a notch to align with the slit and receive the tube. In both a compressive direction of rotation under a threshold torque and an opposite, decompressive direction of rotation, the internal feature is configured for engagement with a resilient feature of the fitting such that rotation of the torque application assembly causes a fitting rotation. In a compressive direction of rotation at or above the threshold torque, rotation of the torque application assembly fails to cause a fitting rotation.

### CROSS REFERENCE TO RELATED APPLICATIONS

The present specification claims the benefit of priority to U.S. Provisional Patent Application Ser. No. 62/329,469, filed Apr. 29, 2016, the entirety of which is incorporated by reference herein.

### TECHNICAL FIELD

The present specification relates generally to tightening tools and fluidic systems and, more particularly, to tightening tools for use with torque-limited fittings and to systems including tightly-spaced torque-limited fittings for which the tightening tool may be used to rotate the fittings.

### BACKGROUND

In fluidic systems, including microfluidic systems, coupling of tubing to a port of a fluidic device or apparatus may be accomplished through a fitting that creates a fluid-tight seal between the tubing and the port. When multiple tubes and fittings must be connected to a single device or apparatus, a tight-pitch configuration may be required, in which the fittings are spaced very closely together. The tight-pitch configuration presents challenges and limitations with regard to the number of fittings that can be arranged on the fluidic port and also with regard to the ability of a user to easily connect or disconnect the fittings.

Accordingly, needs exist for increasing the number of fittings that can be arranged around a fluidic port, as well as for means to connect or disconnect fittings arranged in a tight-pitch configuration.

### SUMMARY

In one embodiment, a tightening tool configured to work in combination with torque-limited fittings may include a tool body extending between a tool manipulation end and a fitting receiving end opposite the tool manipulation end, and a torque application assembly disposed within the fitting receiving end of the tool body. The tool body may include a slit extending between the tool manipulation end and the fitting receiving end and configured to receive a tube extending from a torque-limited fitting. The torque application assembly may be configured to receive the torque-limited fitting and may include a notch and at least one internal feature projecting from an inner wall of the torque application assembly. The notch may be configured for alignment with the slit of the tool body and configured to receive the tube extending from the torque-limited fitting. The at least one internal feature projects from an inner wall of the torque application assembly and is configured for engagement in a decompressive direction of rotation of the torque application assembly with at least one resilient feature projecting from an outer wall of the torque-limited fitting such that rotation of the torque application assembly causes a rotation of the torque-limited fitting in the decompressive direction of rotation.

In another embodiment, an assembly may include a torque-limited fitting comprising an outer wall and at least one resilient feature projecting from the outer wall, a tube extending from the torque-limited fitting, and a tightening tool. The torque-limited fitting may be configured for receipt in a port of a fluid-handling device. The tightening tool may include a tool body extending between a tool manipulation end and a fitting receiving end opposite the tool manipulation end, and a torque application assembly disposed within the fitting receiving end of the tool body. The tool body may include a slit extending between the tool manipulation end and the fitting receiving end and configured to receive the tube. The torque application assembly may be configured to receive the torque-limited fitting and may include a notch, an inner wall, and at least one internal feature projecting from the inner wall. The notch may be configured for alignment with the slit of the tool body and configured to receive the tube extending from the torque-limited fitting.

In yet another embodiment, a method for fitting a torque-limited fitting to a port of a fluid-handling device may include positioning the torque-limited fitting in coaxial alignment with a port of the fluid-handling device, positioning a torque application assembly disposed within a fitting receiving end of a tool body of a tightening tool about the torque-limited fitting, and rotating the torque application assembly through a rotation of the tool body in a compressive direction of rotation. The torque application assembly may include a notch configured to receive a tube extending from the torque-limited fitting. When a threshold torque has not yet been reached while the torque application assembly is rotated in the compressive direction of rotation, a plurality of internal features projecting from an inner wall of the torque application assembly may engage with a plurality of resilient features projecting from an outer wall of the torque-limited fitting with a sufficient force to cause rotation of the torque-limited fitting. When the torque threshold has been reached or exceeded while the torque application assembly is rotated in the compressive direction of rotation, the plurality of internal features do not engage with the plurality of resilient features with a sufficient force to cause rotation of the torque-limited fitting.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 is a side view of a tightening tool, according to one or more embodiments shown and described herein.

FIG. 2 is a perspective view of a torque application assembly of the tightening tool, according to one or more embodiments shown and described herein.

FIG. 3 is a perspective view of a tightening tool, according to one or more embodiments shown and described herein, applied to a multi-use torque-limited fitting in a port of a fluid-handling device.

FIG. 4 illustrates positioning of a tightening tool, according to one or more embodiments shown and described herein, on a multi-use torque-limited fitting in a port of a fluid-handling device.

FIG. 5 is a side view of an example fluid-handling device incorporating standard and tall multi-use torque-limited fittings, the tightening or loosening of any of which may be accomplished with a tightening tool according to one or more embodiments shown and described herein.

FIG. 6 is a side view of a multi-use torque-limited fitting, the tightening or loosening of which may be accomplished with a tightening tool according to one or more embodiments shown and described herein.

FIG. 7 is a cross section of a tightening tool, according to embodiments shown and described herein, when engaged with a multi-use torque-limited fitting to tighten or loosen the fitting.

### DETAILED DESCRIPTION

In some fluidic applications involving fittings that are insertable into a fluid port, the fittings may be spaced so closely together that there may be difficulties in tightening them by hand. The difficulties may be exacerbated particularly in microfluidic applications involving fittings that are very small, sometimes on the order of a few millimeters in height. Therefore, there are needs for specially designed tools that can facilitate tightening and loosening of such fittings. Tightening tools that address this need, particularly for torque-limited fittings, are described in this specification. The tightening tools may include at least one torque application assembly configured such that when torque less than a threshold level is applied to the tightening tool, rotation of the tightening tool in a compressive direction of rotation forces the torque-limited fitting to rotate with the tightening tool. Further, the tightening tools may include at least one torque application assembly such that when torque greater than the threshold level is applied to the tightening tool, rotation of the tightening tool in the compressive direction of rotation fails to force the torque-limited fitting to rotate with the tightening tool. The at least one torque application assembly is designed to ensure that that the tightening tool always rotates the torque-limited fitting when a user rotates the tightening tool in a loosening direction, but that the tightening tool rotates the torque-limited fitting only until a threshold torque is reached when a user rotates the tightening tool in a tightening direction. Thereby, over-tightening of the fluidic coupling may be prevented. The tightening tool also is configured to be used for fitting arrangements that are closely spaced, such that the use of known torque-limiting devices having caps that can be hand-tightened, for example, is not practicable.

Embodiments of tightening tools for torque-limited fittings and applicable systems will now be described with reference to the figures. It should be apparent that numerous modifications and variations to the specific embodiments are possible and that the descriptions herein and their depictions in one or more figures should not be regarded as limiting.

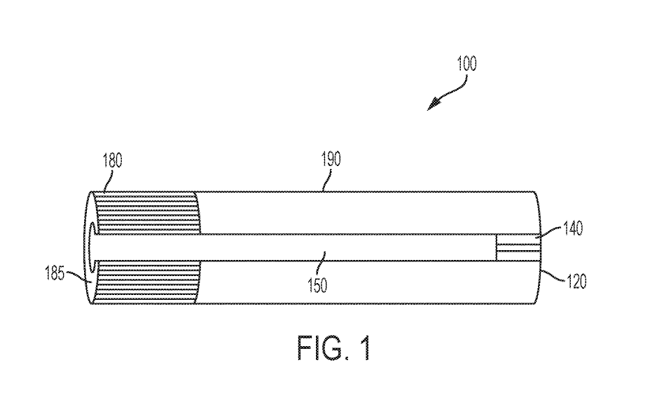

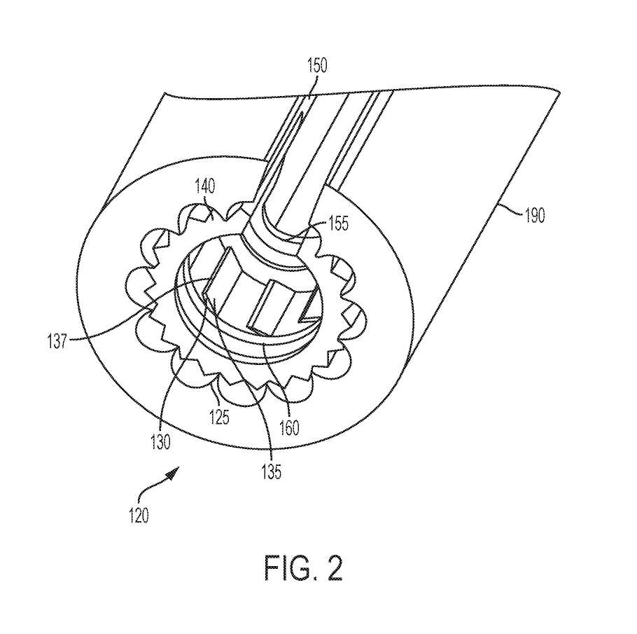

Referring to FIGS. 1 and 2, a tightening tool 100 may include a tool body 190, having a fitting receiving end 120 and a tool manipulation end 185 opposite the fitting receiving end 120. The tool body 190 may be generally cylindrical (as shown in FIG. 1) or may have another suitable geometric shape to increase usability. The tool manipulation end 185 may include one or more tactile features or friction producing features such as grooves or a grip 180 (as shown), a handle (not shown), or any suitable means to facilitate turning the tightening tool 100 by hand or with a tool such as a wrench. In some embodiments, the center of the tool body 190 may be hollow (as shown in FIG. 1) to accommodate a length of tubing that may be inserted through a fitting that the tightening tool 100 is used to tighten or loosen. In such embodiments, the tool body 190 may include a slit 150 to facilitate engaging the tightening tool 100 to a fitting when tubing is present. In other embodiments, the tightening tool 100 may have a solid interior, except for a space that accommodates a torque limiting component 140, which will now be described.

Still referring to FIGS. 1 and 2, during use of the tightening tool 100, a torque limiting component 140 is disposed inside the tool body 190 at the fitting receiving end 120. In embodiments, the torque limiting component 140 may include a notch 155 that accommodates a length of tubing that may be inserted through a fitting that the tightening tool 100 is used to tighten or loosen. The torque limiting component 140 includes one or more internal features 130 inside the torque limiting component 140. The internal features 130 are configured to engage with features of a fitting to ensure a limitation on the amount of torque that can be applied to the fitting to further tighten the fitting, as will be described in greater detail below. The torque limiting component 140 may be secured inside the tool body 190 by tension or, alternatively, by projections 125 defined by the fitting receiving end 120 of the tool body 190. In some embodiments, the torque limiting component 140 may be permanently secured inside the tool body 190. In some embodiments, the torque limiting component 140 may be removable from the tool body 190 or provided as a removably insertable piece adapted to be disposed within the tool body 190.

The internal features 130 of the torque limiting component 140 may include, for example, a sloped face 135 configured to limit the ability to further tighten a fitting when a threshold torque is exceeded in a tightening direction and an abutment 137 that enables free rotation of a fitting in a loosening direction at all times. In embodiments, at least one internal feature 130 projecting from the inner wall of the torque limiting component 140 comprises an abutment 137 as a first internal feature surface and a sloped face 135 as a second internal feature surface.

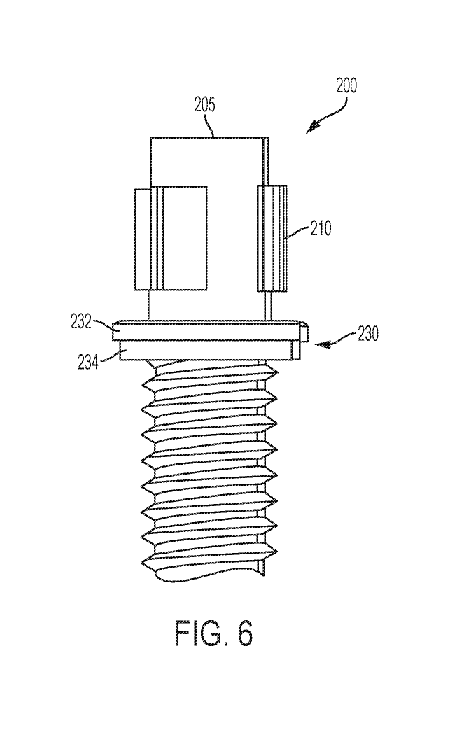

Referring to FIG. 6, an exemplary torque-limited fitting 200 for which the tightening tool 100 may be used may include one or more resilient features 210 that engage the internal features 130 of the tightening tool 100. For example, the one or more resilient features 210 may be configured to engage the sloped face 135 during tightening and to be stopped against the abutment 137 during loosening. In particular, during tightening, the one or more resilient features 210 may have a limited ability to flex inwardly, such that when low levels of torque are applied to the torque-limited fitting 200 during tightening the one or more resilient features do not flex inwardly but when high levels of torque are applied during tightening the one or more resilient features 210 do flex. Additional types of the torque-limited fittings may include levers such as those present inside torque-limiting fittings described in U.S. Pat. No. 7,954,857, which is incorporated by reference herein in its entirety. It should be noted that the torque-limited fittings described in U.S. Pat. No. 7,954,857 are integral and unitary fittings having wide body portions not intended to be removable from their threaded body portions. In contrast, the exemplary torque-limited fitting 200 of FIG. 6 lacks an outer body portion and the one or more resilient features 210 are exposed to be engaged with internal features 130 of a tightening tool 100 that is applied to tighten or loosen the exemplary torque-limited fitting 200.

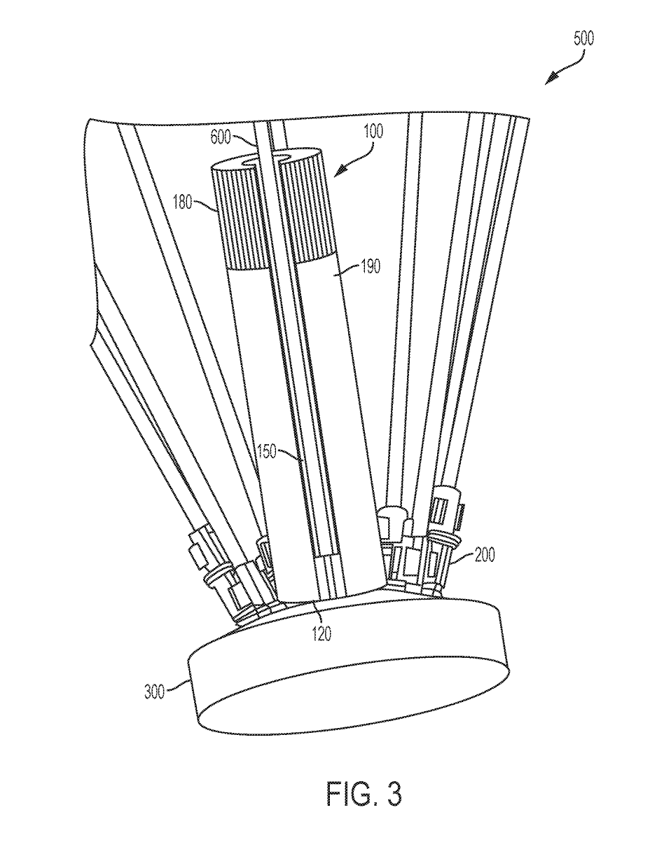

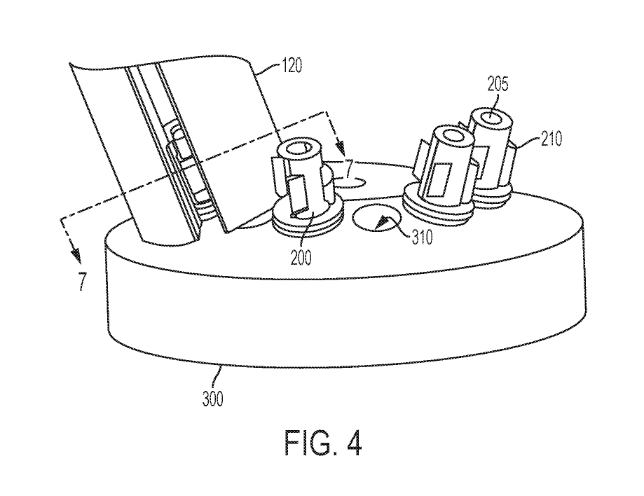

As exemplified in the installation assembly 500 of FIG. 3, the tightening tool 100 may be used to engage and tighten a torque-limited fitting 200 into a port 310 (see FIG. 4) of a fluid-handling device 300 so as to form a fluid-tight seal. For example, a threaded portion of the tightening tool 100 may engage with a threaded portion of the port 310 either to loosen the torque-limited fitting 200 in a decompressive direction of rotation with respect to the port 310 or to tighten the torque-limited fitting 200 in a compressive direction of rotation with respect to the port 310 up to a threshold torque. While engaged with the torque-limited fitting 200, the torque limiting component 140 inside the tool body 190 provides that when a torque less than a threshold level is applied to the tightening tool 100, rotation of the tightening tool 100 in the compressive direction of rotation forces the torque-limited fitting 200 to rotate with the tightening tool 100 but when a torque greater than the threshold level is applied to the tightening tool 100, rotation of the tightening tool 100 in the compressive direction of rotation fails to force the torque-limited fitting 200 to rotate with the tightening tool 100. Limiting the torque applied to the torque-limited fitting 200 to position the torque-limited fitting 200 in the port 310 of a fluid-handling device 300 prevents the torque-limited fitting 200 from being over tightened by the tightening tool 100.

Referring to FIGS. 2 and 3, the tightening tool 100 may be applied to tighten or loosen a torque-limited fitting 200 even when a tube 600 is installed through the torque-limited fitting 200 through a tubing channel 205 (FIG. 6) of the torque-limited fitting 200. To enable the tightening tool 100 to engage the torque-limited fitting 200 while a tube 600 is present, the tightening tool 100 may include a slit 150 defined longitudinally in the tool body 190 of the tightening tool 100 and sufficiently wide to allow the tube 600 to pass through one side of the tightening tool 100. The slit 150 may extend along one entire side of the tightening tool 100, longitudinally spanning from the fitting receiving end 120, across the tool body 190, and to the tool manipulation end 185. The torque limiting component 140 may also include a notch 155 that accommodates the tube 600. Thus, in embodiments the tightening tool 100 may have a longitudinal hollow portion fully accommodating the tube 600 within the tightening tool 100 while the tightening tool is engaged with the torque-limited fitting 200.

In embodiments, the notch 155 of the torque limiting component 140 may be similar in width to the slit 150 or may have a greater width than the slit 150. The torque limiting component 140 may further include a seal receiving portion 160 (FIG. 2) sized and configured to receive and hold a seal portion 230 (FIG. 3) of a torque-limited fitting 200. The seal portion 230 may be disposed between the threaded portion and a levered portion of the torque-limited fitting. As a non-limiting example, and referring to FIG. 6, the seal portion 230 may include an upper seal portion 232 and a lower seal portion 234. The upper seal portion 232 may be molded to the lower seal portion 234 and have a diameter that is larger than a diameter of the lower seal portion 234. Further, the diameter of the upper seal portion 232 may be larger than a largest diameter between resilient features 210 of a torque-limited fitting 200. Both the upper seal portion 232 and the lower seal portion 234 may be of a circular shape, though other shapes are within the scope of this disclosure. The seal receiving portion 160 of the torque limiting component 140 of the tightening tool 100 has a diameter of a length sufficient to receive and accommodate the upper seal portion 232 of the seal portion 230.

Referring to FIGS. 3 and 4, the tightening tool 100 may be applied to a torque-limited fitting 200 even when multiple torque-limited fittings 200 are positioned closely together or are positioned near obstructing objects. In the fluid handling device 300 of FIG. 4, for example, several ports 310 may be present that each accept a torque-limited fitting 200. A fluid-handling device 300 may have ports 310 in a tight-pitch configuration or otherwise spaced very closely together, such that the tightening tool 100 is the only available method of tightening the torque-limited fitting 200, which lacks any type of grip or cap for tightening by hand. Thus, if the ports 310 are positioned so closely together that a torque limiting cap cannot be fit on each of the torque-limited fittings 200, the tightening tool 100 may be used to tighten or loosen the torque-limited fittings 200 instead.

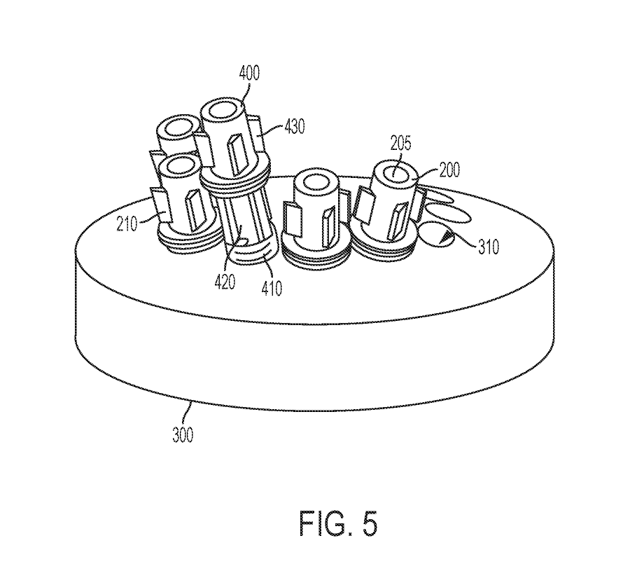

Referring to FIGS. 4 and 5, in conditions under which torque-limited fittings 200 are positioned closely together or are positioned near obstructing objects, one or more extended torque-limited fittings 400 may be used. Extended torque-limited fittings 400 comprise an extension portion 420 between a threaded portion 410 and a levered portion 430. The extended torque-limited fittings 400 enable the ports 310 to be more closely packed. The tightening tool 100 may be used together with the extended torque-limited fittings 400 to simplify installation of the torque-limited fittings into the ports 310 of the fluid-handling device 300.

Referring to FIGS. 3, 4, and 5, an installation assembly 500 or fluidic system including torque-limited fittings may be assembled by using a tightening tool 100, one or more torque-limited fittings 200, one or more tubes 600, one or more ports 310, and one or more fluid-handling devices 300. The assembly may also include one or more extended torque-limited fittings 400. The tightening tools 100 of the installation assembly 500 are operable to engage a torque-limited fitting 200, and install torque-limited fittings 200 into ports 310 of the fluid-handling devices 300. Additionally, the tightening tools 100 of the installation assembly 500 are operable to engage an extended torque-limited fitting 400, and install the torque-limited fitting into the port 310 of the fluid-handling devices 300. In another embodiment, the installation assembly 500 may include a tube 600 coupled to one or more torque-limited fitting 200 or one or more extended torque-limited fitting 400, wherein the tube 600 may be passed through a slit 150 of the tightening tool 100 so the tightening tools 100 may engage one or more resilient features 210 of the torque-limited fitting 200 or the extended torque-limited fitting 400.

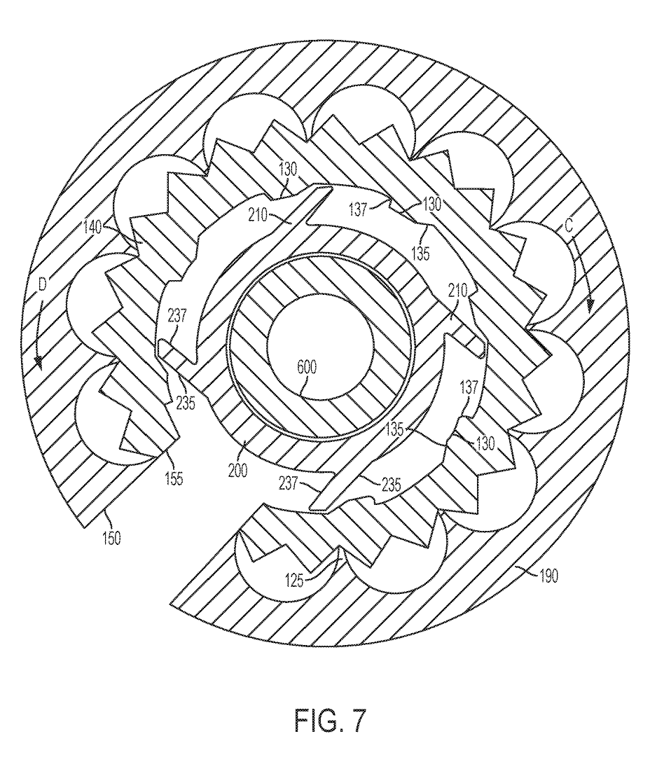

Referring to the cross-section of FIG. 7, the tightening and loosening actions of the tightening tool 100, according to embodiments previously described, on a torque-limited fitting 200 will now be described. During tightening or loosening of the torque-limited fitting 200, the torque limiting component 140 inside the tool body 190 of the tightening tool 100 is positioned about the torque-limited fitting 200. The torque-limited fitting 200 includes a plurality of resilient features 210, each including a sloped surface 235 and an abutment surface 237. The torque-limited fitting 200 of FIG. 7 includes four resilient features 210, though for the sake of clarity not all are labeled. It should be understood that more than four or fewer than four such resilient features may be present and that the four exemplified in FIG. 7 are for illustrative purposes only. In embodiments, the torque-limited fitting 200 may include a single resilient feature 210. In embodiments, at least one resilient feature 210 projecting outwardly from the torque-limited fitting 200 may include an abutment surface 237 as a first resilient feature surface and a sloped surface 235 as a second resilient feature surface.

As previously described, the torque limiting component 140 includes a plurality of internal features 130 projecting inwardly toward the torque-limited fitting 200. In the embodiment of FIG. 7, each of the internal features 130 includes a sloped face 135 and an abutment 137. The torque limiting component 140 of the embodiment of FIG. 7 includes seven of the internal features 130, though for the sake of clarity not all are labeled. It should be understood that more than seven or fewer than seven such resilient features may be present and that the seven exemplified in FIG. 7 are for illustrative purposes only. In embodiments, the torque limiting component 140 may include a single internal feature 130. The notch 155 of the torque limiting component 140 may be aligned with the slit 150 in the tool body 190 to accommodate a length of tubing 600 that protrudes from inside the torque-limited fitting 200 when the torque limiting component 140 is moved to engagement with the torque-limited fitting 200. In the embodiment of FIG. 7, rotation of the tool body 190 imparts rotation of the torque limiting component 140, owing at least in part to the projections 125 defined in the tool body 190.

As a non-limiting example, when a user desires to tighten the torque-limited fitting 200, the tool body 190 and, in turn, the torque limiting component 140 rotates in a compressive direction of rotation along the direction of arrow C. When the torque applied by the user is less than a threshold torque tailored to the particular type of torque-limited fitting 200 to provide optimal tightening, the resilient features 210 of the torque-limited fitting 200 do not flex when they come in contact with the sloped face 135 of one of the internal features 130. By not bending, the resilient features 130 in turn impart rotation to the torque-limited fitting 200 in the compressive direction, thereby tightening the fitting. When the torque applied by the user is greater than or equal to the threshold torque, however, the resilient features 210 of the torque-limited fitting 200 flex inwardly toward the center of the torque-limited fitting 200 when they contact the sloped face 135 of one of the internal features. The resilient features 210 then slide up the sloped face 135 without imparting any rotation to the torque-limited fitting 200. When the resilient features 210 then pass fully over the internal features 130, their resilience causes them to snap back outwardly with an audible clicking sound. Thereby, overtightening of the torque-limited fitting 200 is prevented.

Still referring to FIG. 7, when a user desires to loosen the torque-limited fitting 200, the tool body 190 and, in turn, the torque limiting component 140 rotates in a decompressive direction of rotation along the direction of arrow D, opposite the compressive direction C. During the loosening, however, the abutment surface 237 of each resilient feature 210 eventually contacts an abutment 137 of an internal feature 130 of the torque limiting component 140 inside the tool body 190. During such contact, neither the resilient feature 210 nor the abutment flexes or otherwise yields. As a result, rotation of the tool body 190 in the decompressive direction D always imparts rotation of the torque-limited fitting 200 in the same decompressive direction D.

In embodiments, the abutment 137 of at least one internal feature 130 faces a first direction, and the sloped face 135 of the at least one internal feature 130 faces a second direction. Further, the abutment surface 237 of at least one resilient feature 210 faces the second direction, and the sloped surface 235 of the at least one resilient feature 210 faces the first direction. The first direction is the decompressive direction of rotation, and the second direction is the compressive direction of rotation.

As previously described, in some embodiments, the torque limiting component 140 may be removable from the tool body 190. In such embodiments, the tool body 190 may be adapted to accommodate various configurations of torque limiting components tailored for use in tightening or loosening various kinds of torque-limited fitting. Accordingly, further embodiments of this disclosure include a kit for a tightening tool according to any embodiment previously described. Referring to FIGS. 1 and 2 the kit may include at least one tool body 190 having a tool manipulation end 185 and a fitting receiving end 120. The fitting receiving end 120 is adapted to receive a torque limiting component 140 therein. The kit further includes at least one torque limiting component 140 configured to be inserted into the tool manipulation end 185 of the tool body 190 provided with the kit. In some embodiments, the kit may include one torque limiting component. In other embodiments, the kit may include a plurality of torque limiting components. In some embodiments the individual torque limiting components may be the same, so as to provide replacement parts should one torque limiting component become worn or otherwise unusable. In other embodiments the individual torque limiting components may be different from each other, so as to provide versatility of the kit for providing multiple configurations of tightening tools 100 that can be constructed to tighten or loosen torque limited fittings of different configurations.

Referring to the figures generally, the tightening tool 100 according to embodiments previously described may be used in methods for tightening or loosening a torque-limited fitting 200 to a port 310 of a fluid-handling device 300. The methods may include first positioning the torque-limited fitting 200 in coaxial alignment with a port 310 of the fluid-handling device 300, then positioning a torque limiting component 140 disposed within a fitting receiving end 120 of a tool body 190 of the tightening tool 100 about the torque-limited fitting 200. The torque limiting component 140 may further include a notch 155 configured to receive a tube 600 that may extend from the torque-limited fitting 200. The methods may further include rotating the tool body 190 and the torque limiting component 140 therein in a compressive direction C of rotation until a the resilient features 210 of the torque-limited fitting 200 no longer engage the sloped face 135 of internal features 130 in the torque limiting component, thereby indicating that a threshold torque has been reached and the torque-limited fitting 200 has been tightened to its optimal tightness.

The methods may further include loosening the torque-limited fitting 200 from the port 310 of the fluid-handling device 300 by rotating the tool body 190 about the torque-limited fitting 200 in a decompressive direction D. When the torque limiting component 140 is rotated in a decompressive direction of rotation opposite the compressive direction of rotation, such as to loosen the fit of the torque-limited fitting 200 from the port 310, the plurality of internal features 130 of the torque limiting component 140 respectively engage with the plurality of resilient features 210 of the torque-limited fitting 200 with a force sufficient to cause rotation of the torque-limited fitting 200. For example, as set forth above and referring to FIG. 7, a rotation of the torque limiting component 140 in the direction of arrow D will then cause a rotation of the torque-limited fitting 200 in the direction of arrow D through a continuous engagement of abutments 137 the plurality of internal features 130 with abutment surfaces 237 of the plurality of resilient features 210.

In embodiments, the methods for tightening or loosening a torque-limited fitting 200 may include positioning a tool body 190 of the tightening tool 100 above and in coaxial alignment with the torque-limited fitting 200. The tool body 190 comprises a slit 150 extending from a tool manipulation end 185 and an opposite fitting receiving end. The slit 150 is configured to receive a tube 600 extending from the torque-limited fitting 200. The methods may further include positioning the torque limiting component 140 disposed within the fitting receiving end of the tool body 190 of the tightening tool 100 about the torque-limited fitting 200. The torque limiting component 140 comprises a notch 155 configured to align with the slit 150 of the tool body 190 to receive the tube 600.

It should now be understood that the embodiments described herein provide for a tightening tool that is able to tighten a torque-limited fitting within a port of a fluid-handling device until a threshold torque without over-tightening over the threshold torque to prevent potential fluid leakage and/or material degradation that may occur through such over-tightening. The tightening tool is also configured to act as a loosening tool without restriction such that the torque-limited fitting may be loosened and/or removed from the port of the fluid-handling direction at any time. The tightening tool includes a torque application assembly at a fitting receiving end configured to receive the torque-limited fitting that is opposite a tool manipulation end through which to rotate the tightening tool in a compressive direction of rotation to tighten the torque-limited fitting or an opposite, decompressive direction of rotation to loosen the torque-limited fitting. The torque application assembly includes a notch configured to receive a tube extending from the torque-limited fitting and to be aligned with a slit in the tool body. The slit in the tool body of the tightening tool is configured to receive the tube along with the notch and is disposed and extends between the tool manipulation end and the fitting receiving end. Thus, the tightening tool may tighten or loosen a torque-limited fitting with respect to a port of a fluid-handling device while a tube extends from the torque-limited fitting. Further, the torque-limited fitting may include at least one extension to simply installation of the torque-limited fittings into ports of the fluid-handling device to providing easier accessibility between the extended torque-limited fitting and the tightening tool for engagement and rotation as described herein.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A tightening tool for torque-limited fittings, the tightening tool comprising:
a tool body having a tool manipulation end and a fitting receiving end opposite the tool manipulation end;
a torque limiting component disposed within or removably insertable into the fitting receiving end of the tool body and configured to receive a torque-limited fitting having at least one resilient feature projecting outwardly from the torque-limited fitting, the torque application assembly comprising:
at least one internal feature projecting from an inner wall of the torque application assembly configured for engagement with the at least one resilient feature of the torque-limited fitting when the tightening tool is rotated in a decompressive direction, whereby rotation of the tightening tool in the decompressive direction causes a rotation of the torque-limited fitting in the decompressive direction.

2. The tightening tool of claim 1, wherein:
the tool body has a slit defined therein from the tool manipulation end to the fitting receiving end;
the torque limiting component comprises a notch aligned with the slit of the tool body; and
the slit and the notch are configured to receive a tube extending out of the torque-limited fitting.

3. The tightening tool of claim 1, wherein the at least one internal feature is further configured for engagement with the at least one resilient feature of the torque-limited fitting when the tightening tool is rotated in a compressive direction opposite the decompressive direction with application of a torque less than a threshold torque, whereby the rotation of the tightening tool in the compressive direction causes a rotation of the torque-limited fitting in the compressive direction.

4. The tightening tool of claim 3, wherein, upon rotation of the torque application assembly in the compressive direction of rotation and reaching the threshold torque, the at least one internal feature is configured to fail to engage with the at least one resilient feature such that rotation of the torque application assembly fails to cause a rotation of the torque-limited fitting in the compressive direction of rotation.

5. The tightening tool of claim 1, wherein:
the at least one internal feature projecting from the inner wall of the torque application assembly comprises an abutment as a first internal feature surface and a sloped face as a second internal feature surface; and
the at least one resilient feature projecting from the outer wall of the torque-limited fitting comprises an abutment surface as a first resilient feature surface and a sloped surface as a second resilient feature surface.

6. The tightening tool of claim 5, wherein:
the abutment of the at least one internal feature faces a first direction, and the sloped face of the at least one internal feature faces a second direction; and
the abutment surface of the at least one resilient feature faces the second direction, and the sloped surface of the at least one resilient feature faces the first direction.

7. The tightening tool of claim 6, wherein the first direction is the decompressive direction of rotation, and the second direction is the compressive direction of rotation.

8. An assembly comprising:
a torque-limited fitting comprising an outer wall and at least one resilient feature projecting from the outer wall, the torque-limited fitting configured for receipt in a port of a fluid-handling device;
a tube extending from the torque-limited fitting; and
a tightening tool comprising:
a tool body extending having a tool manipulation end and a fitting receiving end opposite the tool manipulation end, the tool body comprising a slit defined therein from the tool manipulation end and the fitting receiving end, the slit being configured to receive the tube; and
a torque limiting component disposed within the fitting receiving end of the tool body and configured to receive the torque-limited fitting, the torque application assembly comprising:
a notch configured for alignment with the slit of the tool body and configured to receive the tube extending from the torque-limited fitting;
at least one internal feature projecting inwardly toward the torque-limited fitting.

9. The assembly of claim 8, wherein:
the at least one internal feature is configured for engagement, upon rotation of the torque application assembly in a compressive direction of rotation and under a threshold torque, with the least one resilient feature projecting from the outer wall of the torque-limited fitting.

10. The assembly of claim 9, wherein:
the at least one internal feature is configured for engagement with the at least one resilient feature in a decompressive direction of rotation opposite the compressive direction of rotation.

11. A method for fitting a torque-limited fitting to a port of a fluid-handling device, the method comprising:
positioning the torque-limited fitting in coaxial alignment with the port of the fluid-handling device;
positioning a torque application assembly disposed within a fitting receiving end of a tool body of a tightening tool about the torque-limited fitting, the torque application assembly comprising a notch configured to receive a tube extending from the torque-limited fitting; and
rotating the torque application assembly through a rotation of the tool body in a compressive direction of rotation,
wherein:
when a threshold torque has not yet been reached while the torque application assembly is rotated in the compressive direction of rotation, a plurality of internal features projecting from an inner wall of the torque application assembly engage with a plurality of resilient features projecting from an outer wall of the torque-limited fitting with a sufficient force to cause rotation of the torque-limited fitting, and
when the torque threshold has been reached or exceeded while the torque application assembly is rotated in the compressive direction of rotation, the plurality of internal features do not engage with the plurality of resilient features with a sufficient force to cause rotation of the torque-limited fitting.

12. The method of claim 11, further comprising:
positioning the tool body of the tightening tool above and in coaxial alignment with the torque-limited fitting and a tube extending from the torque-limited fitting,
wherein:
the tool body comprises a slit extending from a tool manipulation end and the fitting receiving end disposed opposite the tool manipulation end,
the slit is configured to receive the tube extending from the torque-limited fitting; and
the notch of the torque application assembly is configured to align with the slit of the tool body to receive the tube extending from the torque-limited fitting.

13. The method of claim 11, further comprising:
when a threshold torque has not yet been reached while the torque application assembly is rotated in the compressive direction of rotation, engaging respective sloped faces of the plurality of internal features of the torque application assembly with respective sloped surfaces of the plurality of resilient features of the torque-limited fitting with a sufficient force to cause rotation of the torque-limited fitting,
wherein:
each sloped face of each internal features faces the compressive direction of rotation; and
each sloped surface of each resilient feature faces the decompressive direction of rotation.

14. The method of claim 11, further comprising:
when a threshold torque has been reached while the torque application assembly is rotated in the compressive direction of rotation, clearing engagement between respective sloped faces of the plurality of internal features of the torque application assembly with respective sloped surfaces of the plurality of resilient features of the torque-limited fitting to fail to provide a sufficient force to cause rotation of the torque-limited fitting.

15. The method of claim 11, further comprising:
rotating the torque application assembly through a rotation of the tool body in a decompressive direction of rotation opposite the compressive direction of rotation, wherein the plurality of internal features of the torque application assembly engage with the plurality of resilient features of the torque-limited fitting with a sufficient force to cause rotation of the torque-limited fitting.

16. The method of claim 15, further comprising:
engaging respective abutments of the plurality of internal features of the torque application assembly with respective abutment surfaces of the plurality of resilient features of the torque-limited fitting with a sufficient force to cause rotation of the torque-limited fitting in the decompressive direction of rotation.

17. The method of claim 16, wherein:
each abutment of each internal feature faces the decompressive direction of rotation; and
each abutment surface of each resilient feature faces the compressive direction of rotation.
